(19) United States
(12) Patent Application Publication
(10) Pub. No.: US 2025/0333545 A1
(43) Pub. Date: Oct. 30, 2025

(54) SYNTHESIS OF CELLULOSE MICRO AND NANOPARTICLES FROM COTTON BANKNOTES

(71) Applicants: The United States of America, as represented by the Secretary of Agriculture, Washington, DC (US); HUGHES ENERGY LLC, YONKERS, NY (US)

(72) Inventors: GABRIEL D. PATTERSON, ALBANY, CA (US); JAMES D. MCMANUS, TRACY, CA (US); WILLIAM J. ORTS, BURLINGAME, CA (US); SAIRA NAZNEEN, BEDWORTH (GB); BRENDAN HUGHES, YONKERS, NY (US); DANE MCSPEDON, POUND RIDGE, NY (US)

(21) Appl. No.: 19/079,817

(22) Filed: Mar. 14, 2025

Related U.S. Application Data
(60) Provisional application No. 63/637,957, filed on Apr. 24, 2024.

(51) Int. Cl. C08B 11/12; B82Y 40/00; C08K 5/095; C08K 5/098; C09D 101/28

(52) U.S. Cl. CPC C08B 11/12; B82Y 40/00; C08K 5/095; C08K 5/098; C09D 101/28

(57) ABSTRACT

Described herein are economic, scalable, and environment-friendly compositions and methods of preparing various nanocellulose-based materials. Inexpensive materials and processing conditions for efficient manufacturing methods are described for preparing compositions; methods of using the compositions are also described.

### CROSS-REFERENCE TO RELATED APPLICATIONS

This application claims the benefit of U.S. Provisional Application No. 63/637,957, titled “SYNTHESIS OF CELLULOSE MICRO AND NANOPARTICLES FROM COTTON BANKNOTES” filed Apr. 24, 2024, which is incorporated herein by reference in its entirety.

### BACKGROUND OF THE INVENTION

There is a quest for sustainable solutions to enhance the security and durability of banknotes and other printing and packaging materials used widely in commerce today.

There are ˜175 billion banknotes in circulation around the world. The majority of banknotes (89%) are made from cotton and incorporate a variety of security features. Cotton banknotes are made from cotton paper, a mix of cotton (75%) and linen (25%). In Europe, for instance, so-called comber noils are used. These are short cotton fibers that are a waste stream from the textile industry. The exact ratio of cotton, linen and other materials are kept secret and can vary between countries. The reason to use cotton paper is that it is light, printable and suitable for security features. Furthermore, cotton fibers are strong, yet soft and flexible. This combination makes cotton paper pure and durable. The security features are made from a variety of materials including polymers, metal threads and specialty inks. End-of-life banknotes are waste, and are typically shredded then incinerated to prevent counterfeiting. These actions need to be done securely, cost money to execute and are often times bad for the environment. They also fail to capture the highest value from the components in the end-of-life banknotes.

The various inventions described herein provide solutions for various such long felt technological needs.

### SUMMARY OF THE INVENTION

Provided in various embodiments are compositions and methods to recover and upcycle highly pure and crystalline cotton fibers and composite additives from an unutilized waste stream of high security end of life banknotes and documents into new materials

Provided herein in various embodiments are scalable, inexpensive, waste-free, and environment-friendly methods of preparing charged cellulose nanofibril (CNF) compositions with a carboxylate charge content of 0.5 to 2.5 mmol/g charge and dimensions of 2-10 nm in diameter and 500-1500 nm in length. (σ=0.5-2.5 mmol/g negative charge, d: 2-10 nm, l: 500-1500 nm) from banknotes by the process of autoclaving cotton banknotes, wet-milling in water using mechanical shearing to obtain a suspension, soaking in water, filtering and washing the blended suspension, impregnation and alkylation of the cellulose residues in suspension with a solvent, and alkalizing agent, and an etherifying agent, filtration and washing followed by dialysis of the alkylated fibers, and; wet-milling of the fibers to provide the alkylated cellulose nanofibrils (CNFs).

Similarly, described herein in various embodiments are methods of preparing charged cellulose nanocrystal (CNC) compositions with a carboxylate charge content of 2.0 to 3.5 mmol/g charge and dimensions of 10-50 nm in diameter and 100-500 nm in length (σ=2.0-3.5 mmol/g negative charge, d: 2-10 nm, l: 100-500 nm).

Also described herein in various embodiments are synthesis of conductive polymer-coated compositions comprising the prepared substrates of cellulose nanofibrils (CNFs) or cellulose nanocrystals (CNCs) having conductance ranging from 1.0×10⁻⁵-1.4×10⁻² S/cm to impart security properties and enable tracking features for product packaging of pharmaceuticals, wines, jewelry, perfumes, devices, electronic goods and merchandise.

Also described herein in various embodiments are methods of manufacturing conductive polymer-coated cellulose nanocrystal and cellulose nanofibril (CNF/CNC) coatings for printing and packaging material comprising the steps of: autoclaving a cellulose feedstock selected from currency notes or high security documents or municipal solid waste conversion of autoclaved feedstock to negatively charged CNF and CNC, preparing a dispersion of conductive polymer-coated CNF/CNC in water (σ=1.0×10⁻⁵-1.4×10⁻² S/cm conductance, 0.1-1.0 w/w % CNF or CNC in water), and coating the conductive nanomaterial at 0.1-1.0 GSM (grams per square meter) coat weight onto paper or cotton/nylon-12 sheet for a final assembly of coated printing and packaging material having an outer conductive layer (coat) with dry thickness of 50 to 100 μm conductive polymer-coated CNF/CNC.

### BRIEF DESCRIPTION OF THE DRAWINGS

FIG. 1 shows a scanning electron microscopy of cotton and poly-cotton banknotes: (a,b) shredded cotton banknotes; (c,d) shredded and autoclaved cotton banknotes; (e,f) shredded and autoclaved cotton/nylon-12 banknotes.

FIG. 2 shows a schematic of protocol to prepare carboxymethyl cellulose nanofibrils (CMCNFs) from banknotes.

FIG. 3 shows a schematic diagram of carboxymethylation of cotton banknotes

FIG. 4 shows light microscopy of the aqueous supernatant and precipitate fractions (5k rpm, 15 min) following the coupled carboxymethylation and mechanical shearing by blender of cotton and poly-cotton banknotes: (a) nylon-12 sheet of poly-cotton banknote in the aq. precipitate; (b) carboxymethyl microfibrils in the precipitate; birefrigent images using cross-polarization showing microfibrils in supernatant (c) and the precipitate (d, of corresponding image b).

FIG. 5. Fourier transform infrared spectroscopy of cotton and poly-cotton (Durasafe) banknotes before (a) and after (b) carboxymethylation-blending.

FIG. 6. Schematic diagram demonstrating potential routes to purify cellulose from cotton banknotes.

FIG. 7 shows open circuit potential (Voc) as a function of polymerization time of aniline in the absence (PANI) and in the presence (CNF/PANI) of cellulose nanofibrils.

FIG. 8 shows an aqueous suspension of PANI coated CNF: green doped (left), and blue doped (right).

FIG. 9 shows UV-Vis spectra of CNF/PANI solutions: (a) dedoped with NH4OH, (b) as-prepared in aqueous HCl solution and (c) doped with HCl

FIG. 10 shows UV-Vis spectra of CNF/PANI solutions doped with different dopants: (a) PANI, (b) PANI (HCl), (c) PANI (TSA), (d) PANI (LSA).

### DETAILED DESCRIPTION

In one embodiment, a method of preparing alkylated cellulose nanofibrils exemplified by carboxymethyl cellulose nanofibrils (CMCNFs) from banknotes by the steps of autoclaving cotton banknotes, wet-milling in water using mechanical shearing to obtain a suspension, soaking in water, filtering and washing the blended suspension, impregnation and alkylation of the cellulose residues in suspension with a solvent, and alkalizing agent, and an etherifying agent, filtration and washing followed by dialysis of the alkylated fibers, and; wet-milling of the fibers to provide the alkylated cellulose nanofibrils (exemplified by CMCNFs) is provided.

In one embodiment, compositions comprising conductive cellulose nanocrystals (CNC) and cellulose nanofibrils (CNF) are described. Other embodiments describe methods of using compositions of conductive cellulose nanocrystals (CNC) and cellulose nanofibrils (CNF) to impart security properties and enable tracking features for printed materials and product packaging of pharmaceuticals, wines, jewelry, perfumes, devices, electronic goods and merchandise.

In one embodiment, a composition comprising conductive nanocelluloses is described. In one embodiment, the composition is a uniform (mono) dispersions of cellulose nanofibrils (CNFs). In one embodiment, the composition is cellulose nanocrystals (CNCs). In one embodiment, the composition is a poly-dispersion of nanocelluloses including cellulose nanocrystals and nanofibrils (CNFs and CNCs).

In one embodiment, the composition has a conductivity of 10⁻⁷ to 10⁻² S/cm.

In one embodiment, the composition has a thickness of 10 nm to 500 μm.

In one embodiment, the composition is a coating composition on a polymeric surface. In one embodiment, the surface is a cotton or nylon-12 currency note surface. In one embodiment, the surface is a paper or fabric. In one embodiment, the paper or fabric is a packaging material which is cleaned and sterilized and reusable. In one embodiment, non-deinking (deinking-free) currency note conversion creates CNF and CNC material with a characteristic color and which enables tracking, recycling and reuse.

In one embodiment, the currency note recycling creates a composition, i.e., CNF/CNC, having the same original color as the end-of-life banknote to deliver pigment to new banknotes, thereby recycling and circulating the dyes and pigments to reduce their waste. In some embodiments, are methods of producing conductive cellulose nanofibril and cellulose nanocrystal (CNF/CNC) coated printing and packaging material by the steps of: autoclaving a cellulose feedstock selected from currency notes or high security documents or municipal solid waste, conversion of autoclaved feedstock to CNF and CNC, synthesizing conductive polymer on the surface of the CNF and CNC substrates, and coating a paper or cotton/nylon-12 with a conductive polymer-coated CNF and CNC dispersion for conductive printing and packaging material. In some embodiments, the coating composition with CNF and CNC material maintains the characteristic spectral properties enabling tracking, recycling and reuse of the coating composition. for use in new banknotes by coating the CNF/CNC onto virgin currency paper/sheet/fiber and other uses.

In various embodiments, methods describe autoclaving end of life banknotes by recovering and transforming cellulose-rich cotton and poly-cotton into new materials. This avoids landfilling and incinerating which in turn avoids carbon emissions. This solution also provides opportunities for circularity as a secondary raw material to create sustainable products.

In one embodiment a method for pretreatment by autoclave under moderate temperature and pressure swells the cellulose fibers and initiates fibrillation. Carboxymethylation and blending yielded micro/nano fibrillated cellulose at over 95% in the aqueous supernatant without deinking or any additional purification steps.

In one embodiment a method for using an autoclave to render retired banknotes and other high security documents such as passports or bonds, into a cellulosic rich fiber that can be converted into valuable cellulose nanofibrils (CNF) and cellulose nanocrystals (CNC) while thereby eliminating the usual disposal method of landfilling or burning while preventing theft and counterfeiting of the material.

In one embodiment a method is carried out chemically using a solvent, an alkalizing agent, an etherifying agent, and a cellulose-containing material.

In one embodiment the solvent is propanol.

In one embodiment the solvent is ethanol.

In one embodiment the solvent is propanol and ethanol.

In one embodiment the solvent is propanol, ethanol, and water.

In one embodiment the solvent is propanol and water.

In one embodiment the solvent is ethanol and water.

In one embodiment the alkalizing agent is sodium hydroxide.

In one embodiment the etherifying agent is sodium monochloroacetic acid (chloroacetic acid).

In one embodiment the etherification reaction (carboxymethylation) is carried out at elevated temperature relative to ambient temperature, for example, 30-90 degrees Celsius.

In one embodiment a method is carried out by enzymatic reaction.

In one embodiment a method is carried out by conversion to CNF and CNC done immediately after the autoclave process to utilize the heat and moisture from the autoclave to optimize the initial reactions.

In one embodiment a method is carried out using enzymes on autoclaved banknotes. The conditions for using enzymes are described in Arvidsson, Environ. Sci. Technol. 2015, 49 (11), 6881-6890 et al incorporated here by reference in its entirety.

In one embodiment a method is carried out on the same site where the retired banknotes are collected to reduce the risk of theft.

In one embodiment a method is carried out by using the recovered fiber to create a first-of-its-kind commemorative banknote made primarily from recovered materials.

In one embodiment a method employs steps wherein an electric, compact, skid based autoclave that takes unsorted MSW at the site and reduces its volume by up to 80% and produces a homogenous fiber from the organic faction. The fiber has many uses including being used as a feedstock for heating systems thereby creating a circular sustainable solution for the facility.

In one embodiment a method employs steps wherein autoclaving of municipal solid waste MSW and high security documents to a cellulosic rich fiber at secure locations such as airports, shipping ports, military bases, and prisons to reduce the number of outside service providers from entering the areas.

In one embodiment a method employs steps wherein the MSW waste is reduced in volume by up to 80%.

In one embodiment a method employs steps wherein the cellulosic rich fiber is sold as a valued material as opposed to paying a fee for the MSW to be removed.

In one embodiment a method employs steps wherein the MSW waste is transformed into pellets that are then used for energy or heat for the secure facility or to sell as a valued material.

In one embodiment a method employs steps wherein banknotes are made primarily from cotton or polymer. The banknote community is moving towards polymer notes as it is perceived that they last longer, hold less bacteria and dirt, are waterproof and use fewer valuable resources in the production process.

In one embodiment a method employs steps wherein CNF and CNC that will be created from processes described herein can be used as a “varnish” by applying a 0.1-1.0 gram per square meter coat weight of CNF or CNC dispersion in water at 1/100 g/g or 1 w/w % giving a dry coat thickness of 50 to 100 μm. which will serve to address the following uses: provide a new security feature; extend the life of the banknote by providing a CNF/CNC coating; bacteria and dirt will wipe off as its similar to a plastic coating; ability to repurpose fiber therefore reducing the impact on the environment.

In one embodiment a method employs steps wherein using an autoclave to render end of life banknotes and other high security documents such as passports or bonds, into a cellulosic rich fiber that can be converted into valuable cellulose nanofibrils (CNF) and cellulose nanocrystals (CNC) that are further converted into valuable new materials.

In one embodiment a method employs steps wherein the CNF and CNC are made into electrically conductive composite fibers

In one embodiment a method employs steps for coating the CNF or CNC with a conductive polymer by in situ polymerization and doping.

In one embodiment a method employs steps wherein the products of the processes are used as a security/anti-counterfeiting measure in new banknotes or other documents needing security features.

In one embodiment a method employs steps wherein the original inks/colorants are retained despite chemical reactions on the banknote fiber leaving the conductive CNF and CNC with a distinct visual indicator color reminiscent of the starting end-of-life banknote.

In one embodiment a method employs steps of using the conductive nature of the nano cellulose as a security feature on the banknotes when the whole banknote has a signature conductive charge.

In one embodiment a method employs steps of using security metal fibers from the end-of-life banknotes or high security documents are recovered for use in new banknotes or secure documents.

In one embodiment a method employs steps wherein inks and colorants are maintained on the CNFs and CNCs and thus recovered for use in new banknotes or secure documents, utilizing the CNFs and CNCs are the ink/colorant delivery system as opposed to batch dying or other industry-average (industry standard) dying techniques.

In one embodiment a method employs steps of using the conductive fibers from to add security and tracking features for high-value-product packaging.

In one embodiment a method employs steps of using the conductive fibers for high value products could be pharmaceuticals, wines, jewelry, perfumes, etc.

In one embodiment a method employs steps of using the conductive fibers from directly in clothing to prevent counterfeiting.

In one embodiment a method employs steps of using the nano cellulose as a varnish replacement on the banknotes (eliminating the need for plastic polymer).

In one embodiment a method employs steps of using the recovered fiber and the conductive fibers to create a security feature for the packaging for storage and transport of the banknotes (both new and used).

In one embodiment a method employs steps of using the non-deinking (or deinking-free) conversions to create CNF and CNC materials with the same inks as those used in the end-of-life banknotes to help track their usage in subsequent products, i.e., the trademarked color for the CNF and CNC materials are merely the same inks retained from the banknotes.

In one embodiment a method employs steps of using the trademarked color of the CNF and CNC to deliver pigment to new banknotes, thereby recycling and circulating the dyes and pigments to reduce their waste.

In one embodiment various methods utilize conductive CNF/CNC fibers to enhance chain of custody monitoring and circular economy verification of packaging materials. By tracking incoming materials before entering the autoclave, treating resulting fibers through a novel invention (which add the ability of the product to carry a conductive signal), the method ensures the traceability and integrity of packaging materials throughout their lifecycle. Advanced software and blockchain technology enable tracking of fiber signatures, verification of product providence, and automatic ledger updates, closing the loop of packaging from manufacturer to consumer to recycler.

In one embodiment a method tracks incoming materials before entering the autoclave, providing transparency and accountability in the sourcing of raw materials.

In one embodiment, the resulting fibers from the process are further treated after production in the autoclave, including the creation of a conductive material, ensuring consistent conductivity and circular economy verification.

In one embodiment, the method is used to track and verify carbon credits and other key environmental factors, promoting sustainability and accountability.

In one embodiment, aadvanced software is designed to track the unique signature of conductive fibers, enabling verification of product providence, and ensuring transparency in the supply chain.

In one embodiment, conductive fibers are used to create blockchain smart contracts that automatically update ledger entries, facilitating seamless tracking and closing the loop of packaging materials.

In one embodiment, the method provides enhanced transparency and accountability throughout the packaging supply chain, ensuring traceability of materials and circular economy verification.

In one embodiment, a method for tracking of environmental factors and circular economy use promotes sustainability and supports environmental initiatives is provided.

In one embodiment, the method advanced software and blockchain technology automate tracking processes, reducing manual errors and streamlining supply chain management.

In one embodiment, the method the method helps businesses comply with regulatory requirements and industry standards for traceability and sustainability in packaging operations.

The methods described herein offer a comprehensive solution for improving chain of custody monitoring, circular economy verification, and environmental tracking of packaging materials, leveraging innovative materials and technologies to meet the evolving needs of the packaging industry.

In one embodiment various methods utilize the conductive fibers to create a better method to track provider responsibility for chain of custody monitoring of packaging materials.

In one embodiment various methods utilize the incoming materials which are tracked before entering the autoclave and the resulting fibers are further treated including adding a conductive signal that will verify the circular economy use of the package material.

In another embodiment, this is used to track and/or verify carbon credits or other key environmental factors.

In one embodiment various methods utilize software designed to track the unique signature of the conductive fibers to verify the providence of those products.

In one embodiment various methods utilize conductive fibers to create block-chain smart content that automatically shows up on the ledger to close the loop of packing going from manufacturer to consumer to collector to “recycler” without the need for files.

In one embodiment various methods utilize the conductive properties to create a trademarked signature for the CNF and CNC materials to help track their usage in subsequent products.

“About” as used herein when referring to a measurable value such as an amount, a temporal duration, and the like, is meant to encompass variations of ±10%, in certain embodiments ±5%, in certain embodiments ±1%, in certain embodiments ±0.1% from the specified value, as such variations are appropriate to perform the disclosed methods.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicates otherwise.

The term “comprising” means “including, but not limited to.” The term “consisting essentially of” means the method or composition includes the steps or components specifically recited, and may also include those that do not materially affect the basic and novel characteristics of the present invention. The term “consisting of” means the method or composition includes only the steps or components specifically recited.

The term nanofibrils refers to fibrils with diameters in the nanometer range (typically, between 2 nm and 10 nm) and lengths in the nanometer to micrometer range (typically, 500-1500 nm)

The term nanocrystal refers to rod-like crystals with diameters in the nanometer range (typically between 10 and 50 nm) and lengths in the nanometer range (typically, 100-500 nm)

The term microscale refers to materials having micrometer (μm) and sub-micrometer dimensions, for example, diameters of more than 50 nanometers (nm) or 0.05 μm, and lengths of more than 1500 nm (1.5 μm)

The term nanoscale refers to materials have nanometer dimensions, for example, diameters of less than 50 nm and lengths less than 1500 nm.

The term cellulose refers to a carbohydrate that is the main component of plant cell walls.

The term bank notes refers to a piece of paper money, constituting a central bank's promissory note.

The term autoclaving refers to using a machine at elevated temperature and pressure relative to ambient temperature and pressure to carry out industrial and scientific processes.

Cotton bank notes refers to a bank note comprising cotton, a cellulose-rich natural fiber.

Alkalizing agent refers to a substance that increases the pH level of a solution, dispersion, suspension, mixture, or fluid, making it more alkaline (basic).

Etherifying agent refers to a compound used in a chemical reaction, specifically etherification, to introduce an ether group (R—O—R′) into a molecule, often by reacting with the alkalized hydroxyl group of another compound like cellulose.

Dialysis refers to a water-based post-treatment of the fiber suspension following the etherification reaction, wherein a semi-permeable membrane (12-14 kilodalton molecular weight size cut off, 12-14 kDa MWCO) containing the fiber suspension is immersed in fresh water to remove waste (for example, residual chemicals, byproducts, salts, and solvents) by means of diffusion.

Defibrillation refers to the mechanical, chemical, or chemical-mechanical process of breaking down or separating cellulose fibers into smaller, more dispersed structures, like cellulose microfibrils (CMF) (specifically, “fibrillation”), or cellulose nanofibrils (defibrillation).

Cellulose microfibrils refers to dispersed microscale cellulose derivative structures resulting from the chemical, mechanical, or chemical-mechanical process of breaking down cellulose fibers into cellulose microfibrils (CMFs) with micrometer diameters and lengths (typically, diameters of 0.05 μm or larger and lengths 1.5 μm or larger).

Cellulose nanofibrils (CNFs), refer to the dispersed nanoscale cellulose derivative structures resulting from the chemical, mechanical, or chemical-mechanical process of breaking down cellulose fibers into CNFs with nanometer diameters and lengths (typically, diameters of 2-10 nm and lengths 500-1500 nm).

Cellulose nanocrystals (CNCs) refer to the dispersed nanoscale cellulose derivative structures resulting from the chemical, mechanical, or chemical-mechanical process of breaking down cellulose fibers into CNCs with nanometer diameters and lengths (typically, diameters of 10-50 nm and lengths 100-500 nm).

Morphologies refers to the form of cellulose derivative produced by breaking down cellulose fibers, i.e., cellulose microfibrils, cellulose nanofibrils, and cellulose nanocrystals.

Conductive nanocelluloses refers to CNFs and/or CNCs coated with a conductive polymer through in situ polymerization

Uniform (mono) dispersions refers to solids in a liquid having consistent size/dimensions (diameter, length) and morphology

Poly-dispersion refers to solids in a liquid having inconsistent or different size/dimensions (diameter, length) and morphology

Non-deinking (deinking free) refers to the any process, e.g., temperature, pressures, chemical, or mechanical, that does not significantly remove or affect the inks/pigments/colors originally present in the starting material.

The invention illustratively disclosed herein suitably may be practiced in the absence of any element (e.g., method (or process) steps or composition components) which is not specifically disclosed herein.

It is to be understood that wherever values and ranges are provided herein, all values and ranges encompassed by these values and ranges, are meant to be encompassed within the scope of the present disclosure. Moreover, all values that fall within these ranges, as well as the upper or lower limits of a range of values, are also contemplated by the present application.

Ranges: throughout this disclosure, various aspects of the disclosed subject matter can be presented in a range format. It should be understood that the description in range format is merely for convenience and brevity and should not be construed as an inflexible limitation on the scope of the disclosed subject matter. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Various embodiments of the claims are shown and described herein. It will be obvious to those skilled in the art that such embodiments are provided by way of example only. Numerous variations, changes, and substitutions will occur to those skilled in the art without departing from the embodiments of claims.

Described below are abbreviations used herein.

Cellulose nanofibrils (CNFs), the dispersed nanoscale cellulose derivative structures resulting from the chemical, mechanical, or chemical-mechanical process of breaking down cellulose fibers into CNFs with nanometer diameters and lengths (typically, diameters of 2-10 nm and lengths 500-1500 nm).

CNC cellulose nanocrystals refer to the dispersed nanoscale cellulose derivative structures resulting from the chemical, mechanical, or chemical-mechanical process of breaking down cellulose fibers into CNCs with nanometer diameters and lengths (typically, diameters of 10-50 nm and lengths 100-500 nm).

CMCNF carboxymethyl cellulose nanofibrils refers to CNFs synthesized by carboxymethylation using an alkalizing agent and an etherifying agent of sodium monochloroacetate.
nm=nanometer refers to a unit of size.
S/cm siemens/centimeter refers to unit of conductivity.
σ refers a symbol used to represent charge content (mmol of charge per gram of material).
μm=micrometer refers to a unit of size.
mmol/g charge refers to millimoles of charger per gram of material.
DS refers to degree of substitution
Voc refers to open circuit potential
GSM refers to grams per square meter
PANI refers to polyaniline
UV-Vis refers to an analytical instrument that measures the amount of ultraviolet (UV) and visible light (Vis) that is absorbed by a sample.
HCl refers to hydrochloric acid.
TSA refers to p-toluenesulfonic acid
LSA refers to sulphonated lignin acid
w/w % solids refers to g per g multiplied by 100 percent.

NaMCA sodium monochloroacetate refers to the etherifying agent used in the etherification or alkalized cellulose.

Coupled autoclaving-defibrillation refers to the combined process of first autoclaving currency notes and second defibrillation by chemical-mechanical or enzymatic-mechanical processes into CNFs/CNCs.

The following examples are intended only to further illustrate the invention and are not intended to limit the scope of the invention as defined by the claims.

All publications, patents, and patent applications mentioned in this specification are herein incorporated by reference to the same extent as if each individual publication, patent, or patent application was specifically and individually indicated to be incorporated by reference.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

### Example 1

### Synthesis of Nanocelluloses

### Materials and Methods.

Materials. Cotton and poly-cotton (cotton/nylon-12) banknotes were autoclaved using the steam-based Wilson System® (0.9 MPa, 180° C., 90 mins, 5 kg MSW). Dried banknotes were milled (Wiley Mill, 0.75 mm sieve) into a powder. Sodium monochloroacetic acid (NaMCA, purity≥98%, Pfaltz&Bauer, M=116.48 g/mol), sodium hydroxide (NaOH, ≥98%, Fisher Scientific, M=40.0 g/mol), ethanol (anhydrous, 99.8%, Sigma Aldrich), and isopropanol (IPA, ACS reagent, 99.5%, Sigma Aldrich) were used as received. Both Millipore and deionized water were used in experiments.

Synthesis of Sodium Carboxymethyl Nanocellulose. 1.0 g of dry, autoclaved banknotes powder was added to 200 mL of 10 v/v % water/isopropanol and mixed (400 rpm) with sodium monochloroacetate (NaMCA), the etherifying agent, at 0.4 g/g for the impregnation step while heating in an oil bath to 55° C. (approx. 30 min). Then, 0.5 g sodium hydroxide was added to the reaction mixture causing the alkalization of accessible hydroxyl groups and, thus, initiating carboxymethylation (2 h, 400 rpm, 55° C.). The reaction was then quenched by removing from heat and immediately filtering (vacuum filtration, Buchner funnel, Whatman No. 4), and rinsing with 200 mL of 70/30 ethanol/water to remove isopropanol, salts, and impurities. Next, the filtered carboxymethyl surface-modified cellulose was added to water, mixed until dispersed, then dialyzed in water (12-14 kDa) until <10 μS/cm. Following, the cellulose was blended for 5, 10, 20, or 30 min (37.5k rpm) and centrifuged for 15 min (5000 rpm, 4,500 g) (Sorvall RC 5B Plus Centrifuge) to obtain the product of etherification-blending-centrifugation, i.e., negatively charged, surface-modified carboxymethyl nanocellulose in the aqueous supernatant.

Aqueous Characterizations. Gravimetric Yield. The average yield of solids in the aqueous supernatant was determined gravimetrically (n=3), i.e.,

$$Yield ( \% ) = ( \frac{mass of oven - dried solids in 1 mL}{mass of 1 mL aqueous supernatant} \times 100 \% ) \times total mass of the supernatant . \qquad ( 1 )$$

Surface Charges and Degree of Substitution. The total surface charge on the nanocelluloses was determined by acid-base conductometric titration (OAKTON pH/Con 510); i.e., first adding hydrochloric acid (HCl, 1 N, 50 μL) in excess to 50 mL of 0.05 w/v % aqueous dispersion of nanocelluloses to convert/protonate any negatively charged groups (COO—Na+) to the corresponding acid form (COOH), while adding sodium chloride (NaCl, 0.5 M, 200 μL) helped to increase the overall conductivity. Titration of the dispersion required 0.01 N NaOH as the titrant. The total carboxyl content (COO—Na+/COOH) (σ, mmol/g) was calculated as

$$σ = \frac{cv}{m} = \frac{c ( {v}_{2} - {v}_{1} )}{m} \qquad ( 2 )$$

where c was the NaOH concentration (M), v1 and v2 were the NaOH volume (mL) used to deprotonate surface COOH groups, and m was the nanocellulose mass in suspension (0.025 g). The a was used to calculate the degree of substitution (DS) by the Eyler method,

$$DS = 0.162 σ \div ( 1 - 0.0 \; 58 σ ) \qquad ( 3 )$$

where (162) was the molecular weight of AGU and (58) the net weight increases for each carboxymethyl group substituted.

Hydrodynamic Diameter. The average hydrodynamic diameter, d, (nm) of the nanocelluloses was estimated from dynamic light scattering analysis on 0.1 w/v % aqueous dispersions with a refractive index of 1.334, absorption of 0.001, 173° measurement angle, triplicate measurements, and 12 10-sec runs per measurement on a Malvern Instruments Zetasizer Nano-ZS (Malvern Panalytical, Westborough, MA).

Nanomorphology and Dimensions. The morphology and nanoscale dimensions of thickness, width, and length were determined from up to 30 individual nanofibrils using atomic force microscopy (AFM) and transmission electron microscopy (TEM). For AFM, about 10 μL of aqueous supernatant was deposited onto a fresh mica surface, air-dried, and mounted on the scanning probe microscopy (SPM) stage of a Dimension Icon AFM instrument (Bruker, Santa Barbara, California, USA). Samples were scanned under ambient conditions using the Soft Tapping Mode with an OTESPA-R3 AFM Probe on (Eurofins, EAG Laboratories, Sunnyvale, California, USA). For TEM, samples were sonicated in a Branson Digital Sonifier 450 in a sound-proof enclosure using an ultrasonic microtip (Emerson Branson Ultrasonics Corp., Brookfield CT) at 30% amplitude for 5 min. A 200-mesh formvar/carbon Cu grid was placed on a wedge of filter paper (Whatman, 597). In sequence, 10 μL 0.1% poly-L-lysine (Ted Pella, Inc., Redding, CA), 10 μL 0.09% sonicated sample, and 10 μL filtered 2% aqueous uranyl acetate were dropped onto the grid and allowed to dry on fresh filter paper between applications per the Campano method. Grids were viewed in an FEI Tecnai 12 transmission electron microscope (Thermo Fisher Scientific, FI, Hilisboro, OR) at 80 kV. Images were captured at 2048×2048 pixel resolution with a Gatan Orius SC 200-1 CCD camera and Digital Micrograph software (Gatan, Inc. Pleasanton, CA),

Light Transmittance (%). The transmittance of the nanofibril-containing aqueous supernatant dispersions was measured from 300 to 800 nm using a UV-spectrophotometer (Molecular Devices, LLC, SpectraMax M3, San Jose, CA). In addition, the transmittance at 550 nm was specifically recorded as it is directly linked to the CNF dimensions, surface area, and interactions, 3 i.e., greater electrostatic repulsion of negatively charged surface groups and better defibrillation into individual CNFs allows for a higher light transmittance.

Solid-State Characterizations. Fourier transform infrared spectroscopy (FTIR) (Thermno Scientific, Nicolet iS10) and thermal gravimetric analysis (TGA) (Mettler Toledo, TGA/DSC 3+, Star System, Columbus, OH) (10° C./min, 50 mL/min N2, 70 μL alumina crucible) were performed on freeze-dried nanocellulose aliquots from 0.1 w/v % aqueous supernatants (−76° C., 5 Pa, FreeZone Plus Cascade Benchtop Freeze Dry System, Labconco, Kansas City, MO).

TABLE 1
Steam autoclaving of shredded Cotton/nylon-12
banknotes using a steam Wilson autoclave.^{a}

| | 1% | Steam | | | |
|---|---|---|---|---|---|
| Sample | H₂SO₄ | Pressure | Temperature | Duration | |
| (kg) | (L) | (bar) | (° C.) | (min) | Results |
| 7 | 0 | 5.5 | 162 | 45 | Quantitative removal of |
| | | | | | nylon-12 from the poly- |
| | | | | | cotton banknote assembly |
| | | | | | though some percentage |
| | | | | | remains. |
| 5 | 5.05 | 9.0 | 180 | 90 | Quantitative removal of |
| | | | | | nylon-12 from the poly- |
| | | | | | cotton banknote assembly |
| | | | | | though some percentage |
| | | | | | remains. |

Note:
Both reactions were performed at constant stream pressurization-depressurization rates of 0.5 bar/min and rotation rate of 4 rpm. The action of the steam removed the nylon-12 sheet however the polymer or its hydrolysis products are still present (redistributed) in the paper material after the autoclave treatment, i.e., nylon has the tendency to adsorb onto cotton fiber surfaces.
^{a}Source: Biorenewables Development Centre, Hughes Energy LLC, Project No. 3477, Attendance at Cotton/nylon-12 Banknote Steam Treatment using Wison Autoclave. Info@biorenewables.org.

TABLE 2
Comparison of Carboxymethyl Cellulose Nanofibrils (CMCNFs) from Banknotes.

| | NaMCA/AGU | CMCNFs | ^{a}Gravimetric | | |
|---|---|---|---|---|---|
| Banknote Type | (mol/mol) | Code | Yield (%) | σ(mmol/g) | DS |
| Shredded Cotton | 1:1 | SCMCNF1 | 91 (±3) | 1.17 | 0.20 |
| | 2:1 | SCMCNF2 | 98 (±2) | 1.26 | 0.22 |
| Autoclaved | 1:1 | ACMCNF1 | 98 (±2) | 0.86 | 0.15 |
| Cotton | 2:1 | ACMCNF2 | 96 (±1) | 1.59 | 0.28 |
| Autoclaved | 1:1 | DCMCNF1 | 95 (±2) | 0.78 | 0.13 |
| Cotton/nylon- | 2:1 | DCMCNF2 | 91 (±8) | 1.67 | 0.30 |
| 12 ® | | | | | |

Approximately 4 L of water per gram of banknotes (<4 L/g) was used to isolate CMCNFs.

The use of trade, firm, or corporation names in this document is for the information and convenience of the reader. Such use does not constitute an official endorsement or approval by the USDA of any product or service to the exclusion of others that may be suitable.

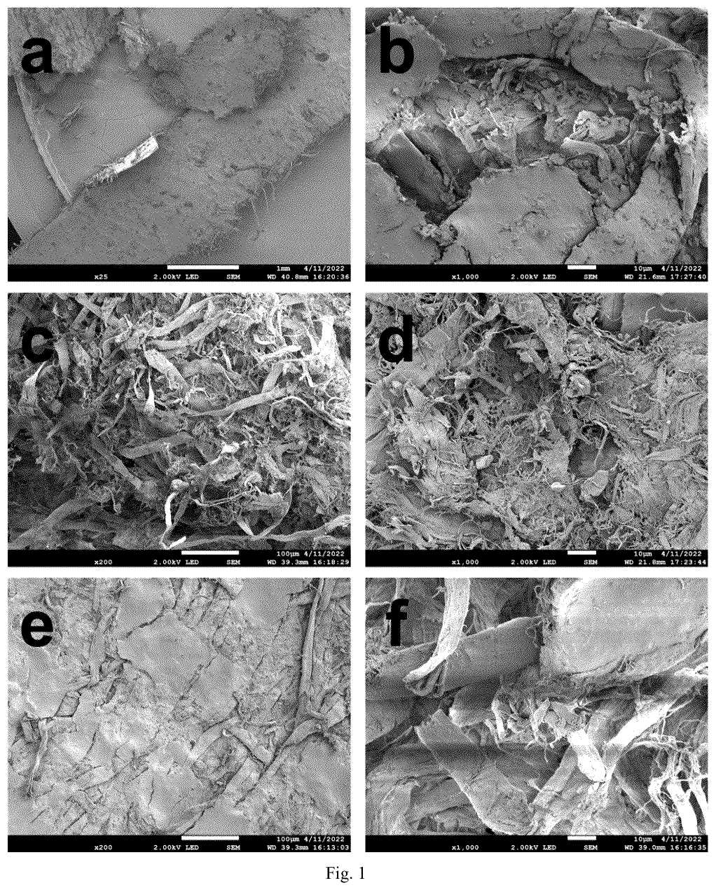

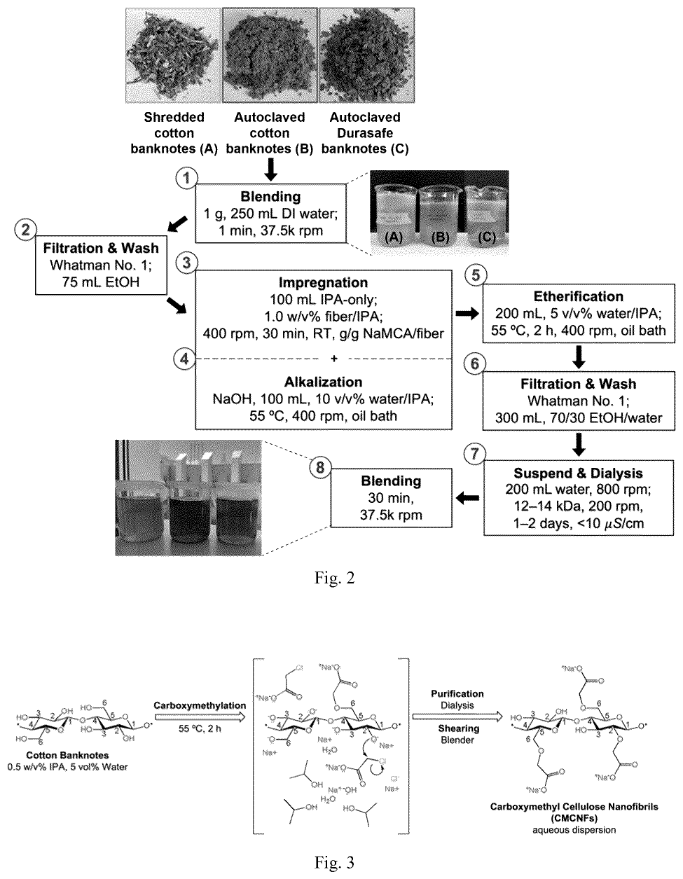

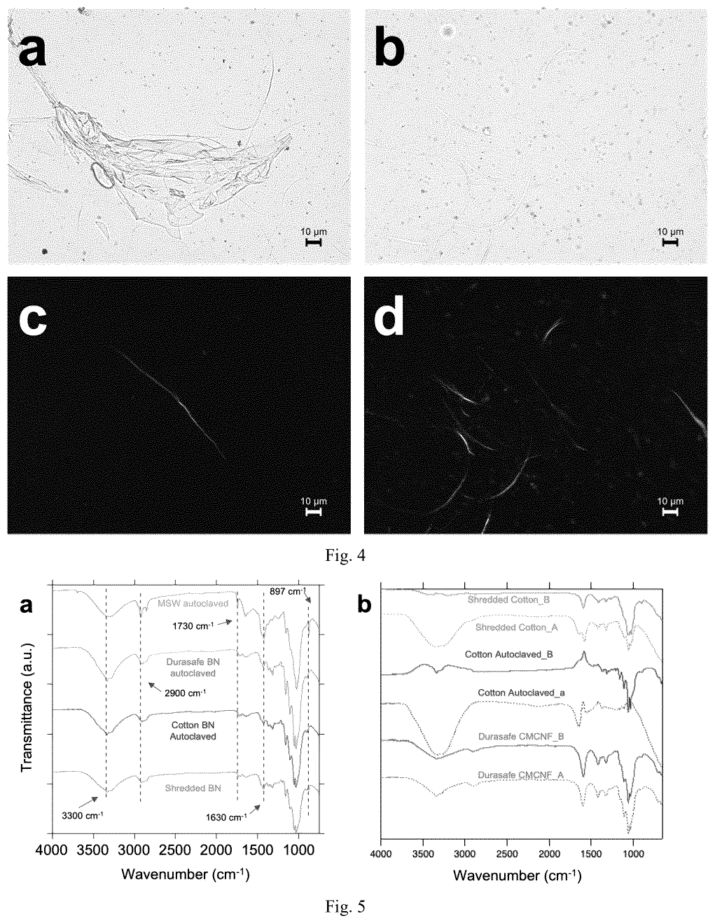

FIG. 1 shows scanning electron micrographs of cotton and poly-cotton fibers. FIGS. 2 and 3 show the step-wise impregnation-alkalization-carboxymethylation of the banknotes to break the cohesive intra- and interchain hydrogen bonding between hydroxyl groups of cellulose fibers. Heterogeneous surface modification by non-regioselective (O2>>O6>O3) carboxymethyl etherification/alkylation with sodium monochloroacetate was performed directly on the shredded and shredded-autoclaved banknotes in isopropyl alcohol. The alkali-stable alcohol facilitates the exclusive alkalization of hydroxyl groups on cellulose (i), resulting in a chemically reactive alkoxide hydroxyl group to react with the sodium monochloroacetate (NaMCA) electrophile via nucleophilic substitution (ii), thus reducing the undesirable side reaction producing sodium glycolate co-product (iii):

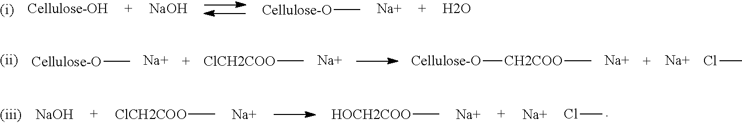

Notably, conducting the alkylation reaction in 10 vol % water/isopropyl alcohol (FIG. 3) was to aid in the solubilization of NaOH in alcohol and facilitate uniform substitution, i.e., surface charge distribution. At a fixed amount of alkalizing agent, varying the amount of etherifying agent would affect the degree of substitution and impacting the quality of the nanocelluloses obtained, i.e., the gravimetric yield, surface charge, and dimensions. In addition, blending for various durations (1-30 min) showed the impact of mechanical shear force on the yield and uniformity (polydisperse to monodisperse) of nanocelluloses in the aqueous supernatant. Mild or brief blending (5 min) showed microfibrils under optical microscopy, and using polarized light illuminated the cellulosic fibrils indicating semi-crystalline structure. In addition, the micrographs showed the presence of nylon polymer sheets from the poly-cotton banknotes.

FTIR analysis of the banknote fibers showed typical cellulosic peak positions (FIG. 5), including Iβ O—H stretching at 3330 cm-1, C—H asymmetric stretching of the C6 CH2 at 2919 cm-1, α-CH2 scissoring at 1417 cm-1, and the glucose ring stretching at 874 cm-1. Accordingly, the C—H asymmetric and symmetric stretching of CH2 at 2923 and 2853 cm-1, respectively, and the C═0 stretching of carboxylic acid at 1745 cm-1 indicated the carboxymethyl groups introduced by alkylation.

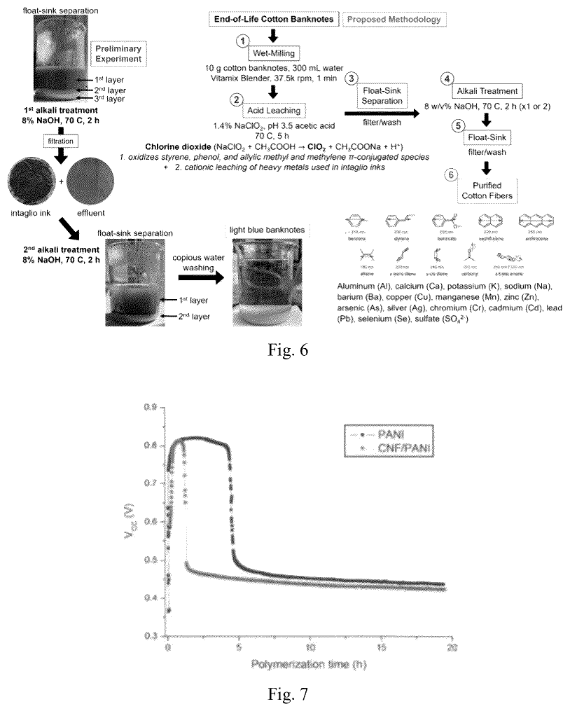

FIG. 6 illustrates potential pathways toward purifying or separating the cotton fibers from the polymer, dyes, and additives prior to alkylation.

### Example 2

### Electrically Conductive Nanocomposites

### Materials and Methods.

Materials. Sodium monochloroacetic acid (NaMCA), sodium hydroxide (NaOH), ethanol, isopropanol (IPA), aniline, ammonium peroxydisulfate (APS), hydrochloric acid (HCl), p-toluenesulfonic acid (pTSA), sulphonated lignin acid (SLA), dodecylbenzenesulfonic acid (DBSA), ammonium hydroxide (NH₄OH) and sulfuric acid are all purchased from Sigma-Aldrich and are used without previous treatment.

Synthesis of Sodium Carboxymethyl Nanocellulose. 1.0 g of dry, autoclaved banknotes powder are added to 200 mL of 10 v/v % water/isopropanol and mixed (400 rpm) with sodium monochloroacetate (NaMCA), the etherifying agent, at 0.4 g/g for the impregnation step while heating in an oil bath to 55° C. (approx. 30 min). Then, 0.5 g sodium hydroxide are added to the reaction mixture causing the alkalization of accessible hydroxyl groups and, thus, initiate carboxymethylation (2 h, 400 rpm, 55° C.). The reaction is then quenched by removing from heat and immediately filtering (vacuum filtration, Buchner funnel, Whatman No. 4), then rinsing with 200 mL of 70/30 ethanol/water to remove isopropanol, salts, and impurities. Next, the carboxymethyl surface-modified cellulose is added to water, mixed until dispersed, then dialyzed in water (12-14 kDa) until <10 μS/cm. Following, the cellulose is blended for 5, 10, 20, or 30 min (37.5k rpm) and centrifuged for 15 min (5000 rpm, 4,500 g) (Sorvall RC 5B Plus Centrifuge) to obtain the product of etherification-blending-centrifugation, i.e., negatively charged, surface-modified carboxymethyl nanocellulose in the aqueous supernatant.

In Situ Polymerization and Nanocomposites Preparation. APS (0.25 g) and aniline (0.1 mL) are dissolved, respectively, in 50 mL and 67 mL of 1.0 M HCl. Several conditions are used to optimize the preparation of the nanocomposites, namely: (i) addition of the aniline/HCl solution to 50 mL aqueous CNF solution (1.16 g/L) followed by addition of this mixture to the APS/HCl solution (ii) addition of the APS/HCl solution to the aqueous CNF solution and then adding this mixture to the aniline/HCl solution, and (iii) use of freeze-dried CNF dispersed in water, which is then added to the aniline solution and this mixture added to the APS solution. The syntheses are monitored by open circuit potential (Voc) using a platinum working electrode and a saturated calomel electrode (SCE). In all cases, after a few hours the solutions will turn light violet, going through a light bluish-green and subsequently dark green until the end of the polymerization. The latter being the color characteristics of polyaniline in the conductive emeraldine oxidation state. By-products are removed by centrifugation: a cycle of washing with water, isolating reactants, and re-suspension, repeated 3 times, and then dialyzed for 3 days. The purified nanocomposite suspension is stored in a refrigerator. A fraction of it is de-doped with 0.1 N NH4OH and then re-doped by overnight addition of 1.0 M HCl, TSA, SLA or DBSA. Films are deposited onto microscope glass slides (75×25×1.2 mm). Premiere. C&A Scientific Co., Inc. USA) by casting directly from the solution of CNF/PANI doped with the different dopants. Alternatively, it could also be doped after the film is prepared by casting the as-dedoped CNF/PANI solution, and then doping with 1.0 M of the dopants described above. The average thickness of these films should range from 50 to 100 μm depending on the polyaniline concentration relative to CNF. Polyaniline-coated cellulose nanofibril suspensions are also freeze-dried in order for the fibrillar structure analysis by scanning electron microscopy (SEM).

Characterization. The CNF/PANI films obtained are characterized by four probe electrical conductivity, UV-Vis spectroscopy and SEM. Electrical conductivity measurements are carried out using a four-probe (de) conductivity apparatus on a Loresta AP meter (model MLP T400. Mitsubishi Petro-chemical co. Ltd.) with space between probes of 5 mm and the tests were performed on 50×20 mm square samples. UV-Vis analysis of aqueous CNF/PANI solutions with different dopants are performed using a Pharmacia Biotech Ultraspec 3000 spectrometer. SEM characterization are carried out on a Model S4700. Hitachi High-Technologies Japan by gluing the samples (both freeze-dried and casted onto glass slides) onto conductive carbon tapes and coating for 45 see with a gold palladium thin layer in a sputter coater (model Desk II. Denton Vacuum. USA).

Electrically conductive cellulose nanofibrils are obtained by the in-situ polymerization of aniline onto CNF surface with little or no precipitation of PANI or formation of PANI aggregates of PANI. The Voc profile are to monitor aniline polymerization and its deposition onto CNF (FIG. 7), which will demonstrate the same trend as observed during conventional chemical oxidative polymerizations of aniline, i.e., an initial increase of the potential from “−0.5 V (vs. SCE), corresponding to the initial solution potential, to “‘−’0.82 V characteristic of the formation of an intermediate polyaniline in the perni-graniline (PN) oxidation state, followed by an abrupt decrease to “‘−’0.43 V due to the reduction of PN to the final polyaniline form in the emeraldine salt (ES) oxidation state. Interestingly, reaction induction time, i.e., the time between addition of APS to polymerization medium and the abrupt increase in Voc to about 0.43 V, is expected to significantly increase indicating that there is a possible interaction between cellulose nanofibrils and aniline in acidic medium as a consequence of the positive charges of aniline and negative charges of cellulose nanofibrils, which makes the growing chains less accessible to addition of monomers at the very beginning of the polymerization.

In contrast to the synthesis of pure, bulk polyaniline polymer precipitation is not expected, suggesting that polyaniline is preferably polymerized onto the CNF surface. The fibrils help prevent further polymer precipitation by acting as a good surface for polymerization. The resulting polyaniline-coated cellulose nanofibrils suspension is a green color characteristic of the formation of polyaniline in the ES form. The green color formation and absence of precipitate is consistent with the work done in the literature for polyester and nylon fibers when the polymerization is carried out under diluted conditions similar to those used in the present work.

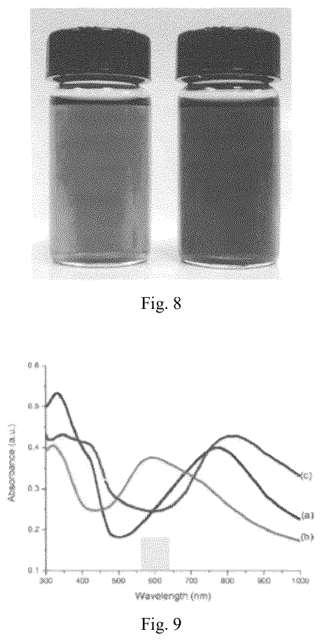

The use of as-prepared CNF, which forms highly stable aqueous suspensions, leads to the possibility of obtaining stable suspensions of electrically conductive PANI coated onto CNF in both doped (green solution) and dedoped (blue) states, as shown in FIG. 8. The best condition to achieve this behavior is by starting with a stable CNF suspension in which aniline is diluted and then by adding a solution of the oxidizing agent (all in aqueous acidic conditions as described in the experimental section). Interesting variations include: (1) addition of the APS solution to the CNF solution and then adding this mixture to the aniline solution, or (2) using freeze dried CNF dispersed in water. The freeze-dried re-suspension is then added to the aniline solution, which is then mixed with the APS solution to produce satisfactory deposition. However, in these latter conditions the CNF/PANI solution is expected to be less stable than the others. This might be because re-dispersion of the freeze-dried CNF into aqueous acidic solution leads to aggregation and then precipitation of CNF despite vigorous application of ultrasound dispersion.

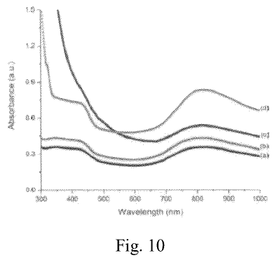

FIG. 9 shows that an electronic absorption spectrum characteristic of the emeraldine doped form of PANI is obtained for the as-synthesized CNF-PANI suspension with maximum absorption peaks at 330 and 785 and a shoulder at 430 nm associated respectively with π−π* and excitonic transitions. The latter absorptions are related to charge carriers (polarons) responsible for promoting the electrical conductivity behavior of polyanilines. As expected, by undoping the polymer this peak is shifted to ˜600 nm (higher transition energy) as seen in FIG. 9, in agreement with that obtained in the literature for the emeraldine base oxidation state. Since the as-synthesized polymer transitions through water dialysis during the purification stage of its preparation, PANI is not completely doped, which could be achieved by treatment with aqueous 1.0 M HCl promoting a further increase in the intensity of the shoulder at 430 nm and in the wavelength of the absorption maximum of the polaronic band to 830 nm consistent with a lower electronic transition energy and consequently a higher doping level. Practically the same behavior is observed for other dopants such as LSA, DBSA and TSA, which could be also used to dope the dedoped CNF/PANI suspension as shown in FIG. 10, for which absorption maxima in the range of 815-830 nm were obtained.

### Example 3

Shredded cotton and poly-cotton (cotton/nylon-12) banknotes were autoclaved using the steam-based Wilson System® at 0.9 MPa, 180° C., and 90 mins in 5 kg batches. FIG. 2 shows the homogenizing effect of autoclaving shredded banknotes yielding a uniform biomass. Fourier transform infrared spectroscopy (FTIR) of the shredded banknotes and autoclaved banknotes showed the same characteristic cellulose transmission peaks of O—H stretching at 3300 cm⁻¹, C—H symmetric and asymmetric stretching around ˜2900 cm⁻¹, O—H deformation at 1630 cm⁻¹, and glycosidic ring stretching a 893 cm⁻¹

We claim:

1. A method of preparing alkylated micro-scale and nano-scale cellulose from banknotes comprising:
autoclaving cotton banknotes,
alkylating cellulosic fibers in the bank notes in suspension with a solvent, an alkalizing agent, and an alkylating agent,
filtering and washing followed by dialysis of the alkylated fibers, and;
defibrillating using mechanical shear force of the chemically-modified fibers to provide the alkylated micro- and nano-scale cellulose derivatives, including cellulose microfibrils, cellulose nanofibrils, and cellulose nanocrystals.

2. The method of claim 1 wherein the alkylated cellulose derivatives have carboxymethyl surface chemistry and micro to nano-scale morphologies and dimensions.

3. The method of claim 1 wherein the alkylating agent is sodium monochloroacetate or monochloroacetic acid.

4. A composition comprising conductive nanocelluloses, including uniform (mono) dispersions of cellulose nanofibrils (CNFs) or cellulose nanocrystals (CNCs), or a poly-dispersion thereof.

5. The cellulose nanofibrils (CNF) composition of claim 4 with a carboxylate charge content of 0.5 to 2.5 mmol/g charge and dimensions of 2-10 nm in diameter and 500-1500 nm in length

6. The cellulose nanocrystals (CNC) composition of claim 4 with a carboxylate charge content of 2.0 to 3.5 mmol/g charge and dimensions of 10-50 nm in diameter and 100-500 nm in length.

7. The composition of claim 4 with cellulose nanofibrils (CNF) or cellulose nanocrystals (CNC) with conductance ranging from 1.0×10⁻⁵-1.4×10⁻² S/cm as a coating composition on a polymeric surface.

8. The coating composition of claim 5 on a polymer surface wherein the surface is a cotton or nylon-12 currency note.

9. The coating composition of claim 5 wherein the surface is a paper or fabric.

10. The composition of claim 9 wherein the paper or fabric is a packaging material which is cleaned and sterilized and reusable.

11. The composition of claim 6 wherein CNF and CNC coated material maintains the unique/characteristic spectral properties enabling tracking, recycling and reuse of the coating composition for bank notes and other uses.

12. The composition of claim 6 wherein currency note recycling creates a composition having the same original color as the end-of-life banknote to deliver pigment to new banknotes, thereby recycling and circulating the dyes and pigments to reduce their waste.

13. The coating composition of claim 4 with a conductivity of 10⁻⁷ to 10⁻² S/cm.

14. The coated composition of claim 4 with a thickness of 10 nm to 500 μm.

15. A method using a composition of conductive cellulose nanofibrils (CNF) and cellulose nanocrystals (CNC) for security properties to enable tracking features for product packaging of pharmaceuticals, wines, jewelry, perfumes, devices, electronic goods and merchandise.

16. A method of manufacturing conductive cellulose nanofibril and cellulose nanocrystal (CNF/CNC) coated printing and packaging material comprising the steps of:
Autoclaving a cellulose feedstock selected from currency notes or high security documents or municipal solid waste,
alkylating of the cellulosic feedstock in suspension with a solvent, an alkalizing agent, and an alkylating agent,
filtering and washing followed by dialysis of the alkylated fibers, and;
defibrillating using mechanical shear force of the alkylated fibers to provide the alkylated micro- and nano-scale cellulose derivatives, including cellulose microfibrils, cellulose nanofibrils, and cellulose nanocrystals, and
coating a paper or cotton/nylon-12 to a CNF and CNC coated printing and packaging material.

17. The method of claim 16 comprising at least one step of etherification (ex. carboxymethylation) and at least one step of mechanical processing (ex. blending).

18. The method of claim 16 further comprising enzymatic processing of fibers.

19. The method of claim 16 wherein the printing material is a currency note.

20. The method of claim 16 wherein the packaging material is cellulose based biodegradable material with security features enabled by the conductive cellulose nanofibrils (CNF) and cellulose nanocrystals (CNC) coating.

21. The method of claim 16 wherein the packaging material is cleaned and sterilized and reusable.

22. The method of claim 16 wherein coupled autoclaving-defibrillation of the currency note conversion to CNF and CNC creates a composition with an identical color for material tracking in recycling and reuse.

23. The method of claim 14 wherein coupled autoclaving-defibrillation currency note conversion creates a composition with the same color as the end-of-life banknotes to deliver pigment to new banknotes, thereby recycling and circulating the dyes and pigments to reduce their waste.
